(19) United States
(12) Patent Application Publication
(10) Pub. No.: US 2014/0033600 A1
(43) Pub. Date: Feb. 6, 2014

(54) FISHING ROD MOUNTING ASSEMBLY

(71) Applicant: Dean McCorkle, Parma Heights, OH (US)

(72) Inventor: Dean McCorkle, Parma Heights, OH (US)

(21) Appl. No.: 13/562,824

(22) Filed: Jul. 31, 2012

(51) Int. Cl. A01K 97/10

(52) U.S. Cl. 43/21.2

(57) ABSTRACT

A fishing rod mounting assembly and method of providing the same is provided. The fishing rod mounting assembly includes a post for removably mounting within one or more cylindrically shaped openings of base mounting assemblies for securing a seat post of a boat seat in a boat. The fishing rod mounting assembly further includes a bar connected to the post, and one or more fishing rod holders mounted to the bar.

### TECHNICAL FIELD OF THE INVENTION

The present invention relates generally to a fishing rod mounting assembly. More specifically, the present invention relates to a post for removably mounting within one or more openings of base mounting assemblies for securing a seat post of a boat seat in a boat, a bar connected to the post, and one or more fishing rod holders mounted to the bar.

### BACKGROUND OF THE INVENTION

In some forms of fishing, a lure or bait is repeatedly cast into the water and retrieved. In those situations, the person doing the fishing must hold the fishing rod at all times. However, in many other forms of fishing, it is not necessary or desirable for the fisherman to hold onto the fishing rod at all times. For instance, in some forms of fishing, the bait or lure is cast into the water, either from the shore or from a boat, and is then allowed to remain in the water until a fish strikes. Since the bait is not being constantly cast and retrieved, there is no need for the fisherman to hold the fishing rod until a fish strikes the bait.

Similarly, another common way to fish is to “troll” for fish, by trailing a line from a fishing rod behind a slowly moving boat, with a bait or lure attached to the end of the line. This allows a wide area of water to be covered, without the need to constantly cast and retrieve the bait. Once a fish is hooked, the boat is stopped and the fish is played to the boat in a normal manner. Again, until a fish is hooked, there is no need for the fisherman to hold the fishing rod in his or her hands. Indeed, in trolling the movement of the bait and the line through the water causes significant dragging forces, which can make holding the fishing rod for extended periods difficult and tiring. Moreover, if each fishing rod is held fisherman can only handle a single rod. This limits the number of lines that can be trolled behind the boat, decreasing the chances of hooking a fish.

### SUMMARY OF THE INVENTION

According to an embodiment of the present invention, a fishing rod mounting assembly is provided. The fishing rod mounting assembly includes a post for removably mounting within one or more cylindrically shaped openings of base mounting assemblies for securing a seat post of a boat seat in a boat. The fishing rod mounting assembly further includes a bar connected to the post, and one or more fishing rod holders mounted to the bar.

According to another embodiment of the present invention, a method of providing a fishing rod mounting assembly. The method includes removably mounting a post within one or more cylindrically shaped openings of base mounting assemblies for securing a seat post of a boat seat in a boat. Further, the method includes connecting a bar to the post, and mounting one or more fishing rod holders to the bar.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices,” or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a front, three dimensional view of a rod mounting assembly for fish rod holders, secured within a boat, in accordance with the present invention.

FIG. 2 is a front, three dimensional view of the rod mounting assembly for fish rod holders, in accordance with the present invention.

FIG. 3 is a rear view of the rod mounting assembly for fish rod holders, in accordance with the present invention.

FIG. 4 is a front three dimensional exploded view of the rod mounting assembly for fish rod holders, in accordance with the present invention.

FIG. 5 is a front three dimensional exploded view of an alternative embodiment of the rod mounting assembly for fish rod holders, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

The fishing rod mounting assembly 10 (hereafter “rod mounting assembly”) for securing fishing rod holders is described in detail below and with particular reference to the drawings. The rod mounting assembly 10 is especially useful on a recreational fishing boat 12 of the type having one or more seats 14 which are built for quick removal, installation at other locations on the boat. Seats 14 have a seat pedestal 15 including a seat post 16 which is adapted to be securely received within a cylindrically shaped swivel mount opening 17 of a base mounting assembly 18 which are located in diverse locations on boat 12 to enable the seats 14 to be moved onto different locations on the boat. Recreational fishing boats as used herein are generally meant to include bass boats, sporting boats, and other small motorized fresh or salt water boats, however, any type of fishing boat is included within the preferred embodiment.

The rod mounting assembly 10 may be constructed of metal, such as aluminum, brass, copper, steel, thermoplastics, thermosetting polymers, rubber, wood, or other suitable material or combination thereof. The rod mounting assembly 10 may be of unitary construction and may be of configurated tubing, rod, or stiffened wire, and/or molded to shape, and/or machined, depending upon the material used. The rod mounting assembly 10 may be painted any suitable or desired color.

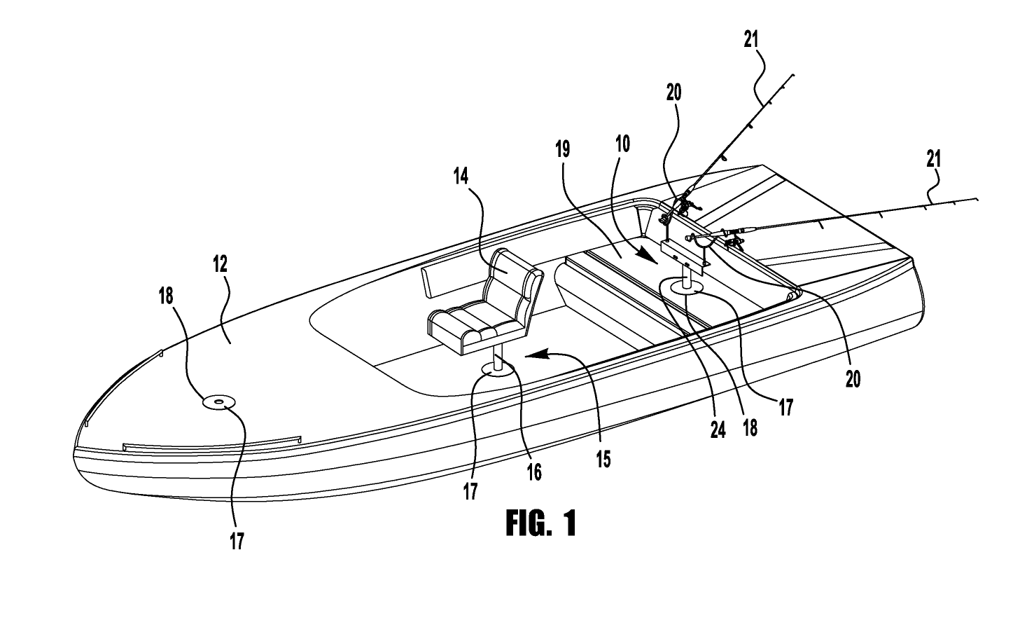

As shown in FIG. 1, the rod mounting assembly 10 of the preferred embodiment is positioned on the cylindrically shaped swivel mount openings 17 located on a bench 19 near the stern of the boat 12. It is within the terms of the preferred embodiment that the rod mounting assembly 10 be removably secured in any of the cylindrically shaped swivel mount openings 17 of base mounting assemblies 18 located in various locations throughout boat 12. While swivel mount openings 17 are typically used to secure the seat posts 16 of seats 14, it is within the terms of the preferred embodiment for the rod mounting assembly 10 to be mounted within the cylindrically shaped swivel mount openings 17 of base mounting assemblies 18.

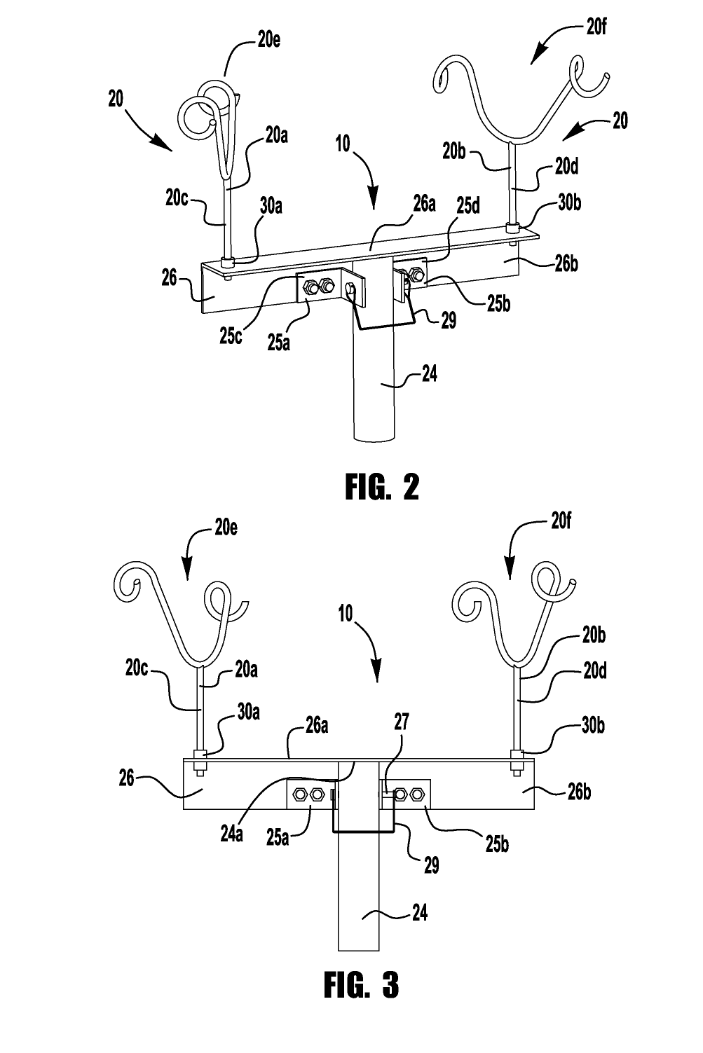

As shown in FIGS. 2, 3 and 4, the rod mounting assembly 10 is designed to have one or more fishing rod holders 20 secured thereto. The fishing rod holders 20 of the type depicted as well as many other designs are commercially available and do not form a part of this invention. As readily imagined, each fishing rod holder 20 is designed to receive the butt end of a fishing rod 21. Once the fishing line is baited and cast into the water, the butt end of the fishing rod 21 is secured in the fishing rod holder 20.

While two fishing rod holders 20a and 20b are shown in FIGS. 2, 3 and 4, it should be understood, the rod mounting assembly 10 can be used to hold just one fishing rod holder 20, two fishing rod holders 20a and 20b as shown, or a greater number, dependent in part on the desires of the fishing enthusiast and in part on the boat's deck lay-out and dimensions. The rod mounting assembly 10 of the preferred embodiment may be utilized either for trolling or for fishing from a fixed location.

FIG. 2 illustrates a front, three dimensional view of the rod mounting assembly 10 with two fishing rod holders 20a and 20b. Rod mounting assembly 10 includes a post 24 which is shaped like seat post 16 of seat 14 and is adapted to be secured within a cylindrically shaped swivel mount opening 17 of base mounting assembly 18. The post 24 can have an exemplary dimension of about 12 inches long and a diameter of about 2⅜ inches in diameter. Post 24 is designed to be securely received in the swivel mount opening 17 so as to resist against rotational movement in the opening 14. It is within the terms of the preferred embodiment that post 24 either be rigid and not move, or adjustable to allow rod mounting assembly 10 to rotate about for different positions of the fishing rods 22.

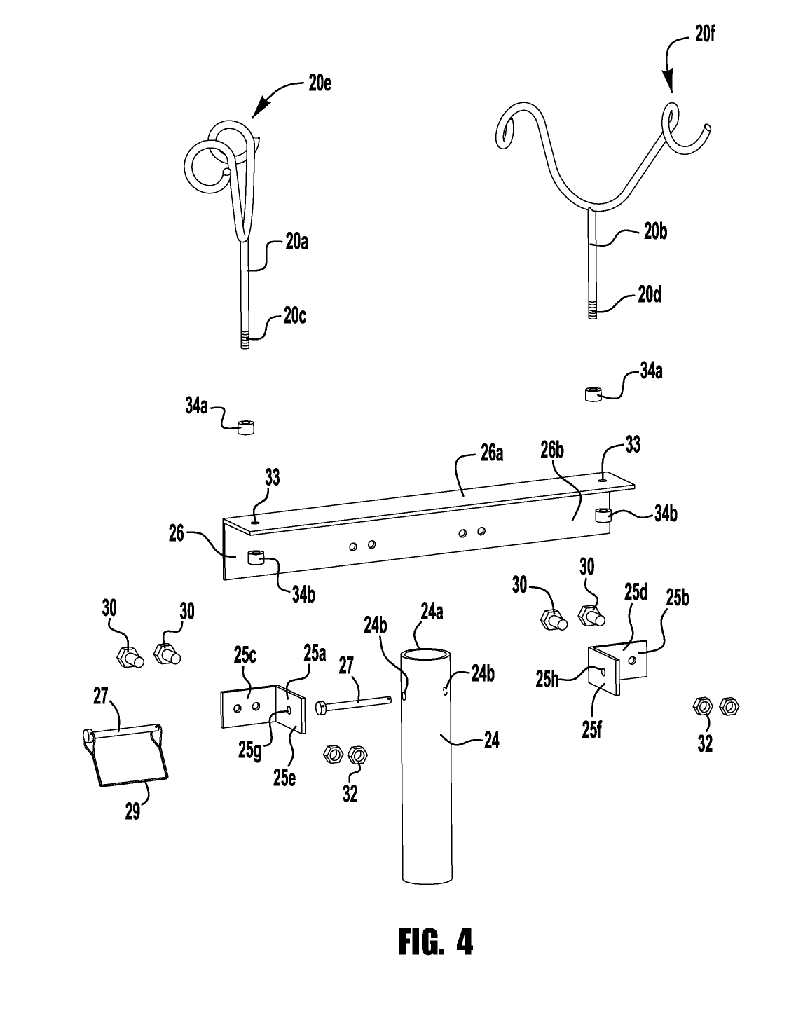

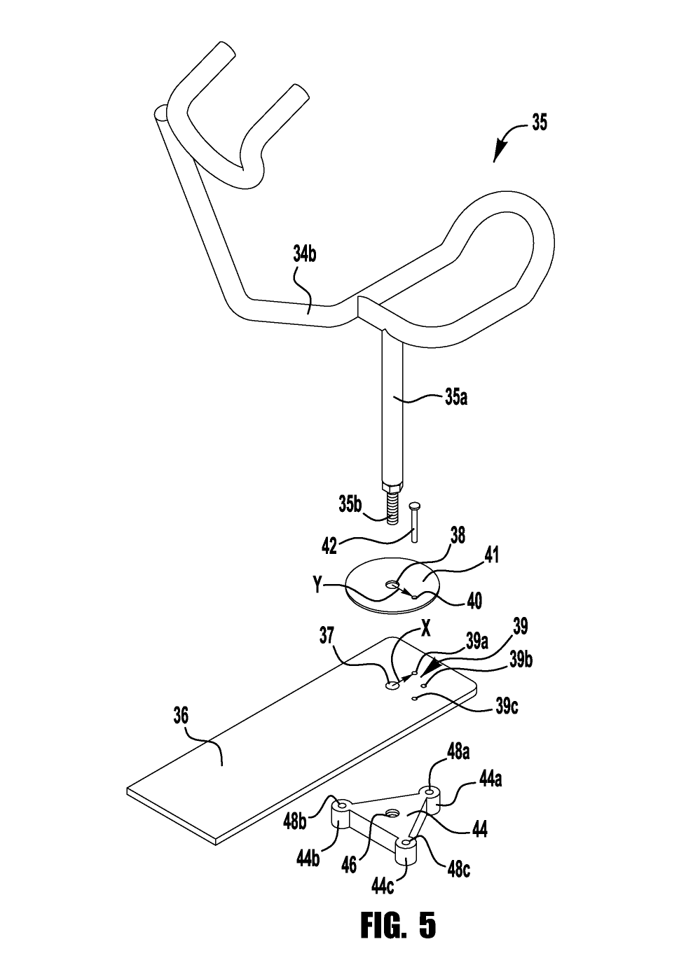

Removably secured to post 20 is an L-shaped bar 26. The underside of flat, upper section 26a of bar 26 is seated against the upper end 24a of post 24. The side section 26b of the bar 26 is seated against the post 24. Two L-shaped connectors, 25a and 25b, are mounted by sections 25c and 25d, respectively, to the side section 26b with screws 30 and nuts 32, as seen in FIG. 4, or other connectors such as for example, rivets or welding. Sections 25e and 25f of L-shaped connectors, 25a and 25b, respectively, project outward from sections 25c and 25d, respectively, and are spaced apart from each other a distance slightly greater than the diameter of post 24 so that post 24 can be seated between the sections 25e and 25f. The post 24 can be secured in place against the underside of flat, upper section 26a and the side section 26b with a rod 27, as shown in FIG. 4, which is received through the holes 25g and 25h of L-shaped connectors, 25a and 25b, respectively, and the opposite holes 24b through the side walls of the post 24. Once the rod 27 is in place, it can be secured with a wire 29.

It is also within the terms of the preferred embodiment to mount the post 24 to the L-shaped bar 26 by a variety of other means, such as by immovably welding the bar 26 to the post 20. Further, although an L-shaped bar is shown, it is within the terms of the preferred embodiment to use any relatively long, straight, rigid piece of solid material such as a thin, rectangularly shaped bar 36 having a flat upper section 36a and a post mounted directly to the underside section by means such as welding.

The L-shaped bar 26 is provided as a means for supporting and pivotally holding a plurality of the fishing rods 21. To that end, a plurality of immobile rod holders 20 are secured to L-shaped bar 26 as illustrated in FIGS. 1-4. While two rod holders 20a and 20b are illustrated, more or less rod holders may be used. Rod holders 20a and 20b may be constructed of any appropriate material, such as a hardened plastic or metal. Rod holders 20a and 20b each have a post portion 20c and 26d, respectively, which is threaded at one end and mounted to the L-shaped bar 26 in through holes 33 by means such as two nuts 34a and 34b. Attached to post portions 20c and 20d are cradles 20e and 20f, upon which a fishing rod 21 is mounted, as seen in FIG. 1.

FIG. 5 illustrates an exploded, three dimensional view of an alternative embodiment of the rod mounting assembly 10. In this embodiment, rod holder 35 is designed to be further stabilized so as not to rotate with respect to the bar 36 that is secured atop post 24 (not shown) in any suitable manner, such as by welding. The bar 36 can also be an L-shaped bar of the type shown in FIGS. 1-4.

Bar 36 includes a hole 37 therethough which is sized to receive the threaded end 35b of the rod holder 35. The bar 36 also has a plurality of smaller holes 39 therethough. The holes 39a, 39b and 39c are arranged with a common radius x to the center of hole 37. While three holes 39a, 39b, 39c are shown. more or less holes can be used with the preferred embodiment.

As described above, rod holder 35 has a post portion 35a that is threaded at one end 35b. A disk 41 having a hole therethrough is mounted to the threaded end 35b of the rod holder 35a and secured thereto by welding or by threads within the central hole 38. Disk 41 includes an opening 40 through which a pin 42 is inserted and secured to the disk 41 by means such as welding. The smaller opening 40 has a radius y from the center of hole 38. The length of radius x and y are equal.

Referring again to FIG. 5, when post 35 is mounted to bar 36, the threaded end 35b is inserted through hole 37. Pin 42 that projects from extends disk 41 is located in one of the plurality of holes 39, such as one of the illustrated holes 39a, 39b and 39c, within bar 36. Pin 42 acts to secure rod holder 35 in place and prevent any undesirably swivel with respect to the bar 36.

In order to reposition rod holder 35, the threaded end of the rod holder is loosened by partially removing triangular threaded nut 44 that secures post 35 to bar 36, raising the rod holder away from the bar 36, twisting the rod holder so that pin 42 is aligned with a different one of the holes 39 and pushing 35 back into place with the disk 41 flush against bar 36, and then the tightening the triangular threaded nut 44 to affix the rod holder to the bar.

Triangular threaded nut 44 secures post 35 to bar 36. Threaded nut 44 has a central hole 46 through which the threaded end 35b is screwed and holes 48a, 48b, and 48c on the triangular ends 44a, 44b, and 44c, respectively, of the threaded nut 44. When threaded nut 44 is screwed flush against the bar 36, post 35 is secure.

According to an embodiment of the invention, the following is a method of providing a rod mounting assembly 10. The method includes removably mounting a post 24 within one or more cylindrically shaped openings 17 of base mounting assemblies 18 for securing a seat post of a boat seat 14 in a boat 12, connecting a bar 26 to the post, and mounting one or more fishing rod holders 20 to the bar. The method further includes removably connecting the bar 26 to the post 24.

The method further includes providing that the bar 26 is an L-shaped bar with a flat, upper section 26a having its underside seated against an upper end 24a of the post 24, and a side section 26b of the bar seated against a side wall of the post. Further, the method includes securing the post 24 in place against the underside of flat, upper section 26a and the side section 26b with a rod 27, which is received through two connectors 25a and 25b, mounted to the underside of the bar 26 on opposite sides of the post, and opposite holes 24b through the side wall of the post.

The method also includes providing that the bar 36 is a relatively long, straight, rigid piece of solid material having a flat upper section 36a, and immovably mounting the post directly to the underside section of the bar. Further, the method includes mounting a plurality of fishing rod holders 20 to the bar 26, and mounting the fishing rod holders in a plurality of positions. Also, the method includes swiveling the post 24 within the one or more cylindrically shaped openings 17 of the base mounting assemblies 18.

The method further includes providing the one or more fishing rod holders 35 with a post portion 35a that is threaded at one end 35b, mounting a disk 41 having a hole therethrough to the threaded end of the rod holder, including a hole 37 in the bar 36, sized for receiving the threaded end of the one or more fishing rod holders, and providing a plurality of smaller holes 39 in the bar, and disposing a pin 42 that extends from the disk in one the plurality of smaller holes within the bar to secure the one or more fishing rod holders in place.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A fishing rod mounting assembly, comprising:
a post for removably mounting within one or more cylindrically shaped openings of base mounting assemblies for securing a seat post of a boat seat in a boat;
a bar connected to the post; and
one or more fishing rod holders mounted to the bar.

2. The fishing rod mounting assembly of claim 1, wherein the bar is removably connected to the post.

3. The fishing rod mounting assembly of claim 2, wherein the bar is an L-shaped bar with a flat, upper section with its underside seated against an upper portion of the post, and a side section of the bar seated against a side wall of the post.

4. The fishing rod mounting assembly of claim 3, wherein the post can be secured in place against the underside of flat, upper section and the side section with a rod, which is received through two spaced connectors mounted to the underside of the bar, and a pair of opposite holes through the side walls of the post.

5. The fishing rod mounting assembly of claim 1, wherein the bar is immovably connected to the post.

6. The fishing rod mounting assembly of claim 5, wherein the bar is a relatively long, straight, rigid piece of solid material having a flat upper section and a post immovably mounted directly to an underside section of the bar.

7. The fishing rod mounting assembly of claim 1, wherein a plurality of fishing rod holders are mounted to the bar.

8. The fishing rod mounting assembly of claim 1, wherein the post swivels within the one or more cylindrically shaped openings of the base mounting assemblies.

9. The fishing rod mounting assembly of claim 1, wherein the one or more fishing rod holders are immobily mounted to the bar.

10. The fishing rod mounting assembly of claim 9, wherein the one or more fishing rod holders are mounted in a plurality of positions.

11. The fishing rod mounting assembly of claim 10, further comprising:
the one or more fishing rod holders having a post portion that is threaded at one end, and a disk having a hole therethrough mounted to the threaded end of the rod holder;
the bar includes a hole therethough which is sized to receive the threaded end of the one or more fishing rod holders, and also has a plurality of smaller holes; and
a pin that extends from the disk disposed in one the plurality of smaller holes within the bar to secure the one or more fishing rod holders in place.

12. A method of providing a fishing rod mounting assembly, comprising:
removably mounting a post within one or more cylindrically shaped openings of base mounting assemblies for securing a seat post of a boat seat in a boat;
connecting a bar to the post; and
mounting one or more fishing rod holders to the bar.

13. The method of claim 12, including removably connecting the bar to the post.

14. The method of claim 13, including providing that the bar is an L-shaped bar with a flat, upper section having its underside seated against an upper end of the post, and a side section of the bar seated against a side wall of the post.

15. The method of claim 14, including securing the post in place against the underside of flat, upper section and the side section with a rod, which is received through two connectors mounted to the underside of the rod on opposite sides of the post, and opposite holes through the side wall of the post.

16. The method of claim 12, including:
providing that the bar is a relatively long, straight, rigid piece of solid material having a flat upper section; and
immovably mounting the post directly to the underside section of the bar.

17. The method of claim 16, further including mounting a plurality of fishing rod holders to the bar.

18. The method of claim 17, further including swiveling the post within the one or more cylindrically shaped openings of the base mounting assemblies.

19. The method of claim 16, further including mounting the one or more fishing rod holders in a plurality of positions.

20. The method of claim 16, further including:
providing the one or more fishing rod holders with a post portion that is threaded at one end;
mounting a disk having a hole therethrough to the threaded end of the rod holder;
including a hole in the bar, sized for receiving the threaded end of the one or more fishing rod holders, and providing a plurality of smaller holes in the bar; and
disposing a pin that extends from the disk in one the plurality of smaller holes within the bar to secure the one or more fishing rod holders in place.
